(19) United States
(12) Patent Application Publication
(10) Pub. No.: US 2005/0237188 A1
(43) Pub. Date: Oct. 27, 2005

(54) Self-propelled cleaner

(75) Inventor: Takao Tani, Osaka (JP)

Correspondence Address: Yokoi & Co.;U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/084,313

(22) Filed: Mar. 18, 2005

(30) Foreign Application Priority Data
Mar. 25, 2004 (JP) JP2004-089360

(51) Int. Cl. G08B 13/00

(52) U.S. Cl. 340/541; 701/23; 901/1; 700/245

(57) ABSTRACT

Although an intercom can stepwise determine a visitor's degree of danger, it can neither check whether an intruder actually invades into a house nor defend the house from an invading intruder. According to the present invention, while a cleaner body roams about a room so as to clean the room, map information is produced. If the body passes nearby a marker, positional information acquired from the marker is added to the map information. The marker is used to specify the position of a base phone included in the intercom or a standby position. In watch mode, whether a watch instruction is received from the base phone is checked. After the cleaner body is moved to the standby position, human body sensors are used to sense whether an intruder has invaded into a house. As soon as invasion is sensed, the cleaner body is moved to face the intruder. Thereafter, imaging is instructed, and photographic image data is acquired and transmitted over a wireless LAN.

### BACKGROUND OF THE INVENTION

1. Field of the Invention

The present invention relates to a self-propelled cleaner comprising a body that includes a cleaning mechanism and a drive mechanism that steers and drives the body. More particularly, the present invention is concerned with a self-propelled cleaner to be used in combination with an intercommunication system (hereinafter, intercom) that includes a camera device which images a visitor, that stepwise determines a visitor's degree of danger on the basis of the visitor's face imaged by the camera device, and that notifies outside of the result of the determination.

2. Description of the Related Art

In recent years, various types of self-propelled robots have been proposed. On the other hand, intercoms can sense a visitor's emergence. Therefore, a proposal has been made of a system in which an intercom notifies a self-propelled robot of a visitor and the robot responds to the notification (refer to Japanese Unexamined Patent Application Publication No. 2002-290586 (Patent Document 1)).

An intercom capable of identifying a visitor has made its debut in recent years. Specifically, the intercom includes a camera device that images a visitor, and discriminates the visitor on the basis of his/her face imaged by the camera device. Images of faces are registered in advance, and referenced in order to determine whether an image of a face matches with any of the registered images. If the image of the face does not match with any registered image, the visitor is suspected of an intruder who is looking at the interior of the house. Thus, a visitor's degree of danger is determined stepwise.

The foregoing conventional self-propelled robot is interlocked with the intercom and responds to a notification sent from the intercom. The self-propelled robot then notifies a resident of presence of a visitor. However, the self-propelled robot is of no use when there is no visitor.

Even if the intercom can stepwise determine a visitor's degree of danger, the intercom cannot check whether an intruder actually invades into a house but cannot defend the house from an invading intruder.

### SUMMARY OF THE INVENTION

The present invention addresses the foregoing problems. An object of the present invention is to provide a self-propelled cleaner that propels itself to clean a house and readily defends the house from an intruder by utilizing a facility for transmitting or receiving information to or from outside by radio.

In order to accomplish the object, the present invention provides a self-propelled cleaner comprising a body that has a cleaning mechanism and a drive mechanism that steers and drives the body. The self-propelled cleaner further comprises: radiocommunication equipment capable of transmitting or receiving predetermined information to or from outside by radio; an intruder information acquisition processor that acquires information on an intruder's visit from an external intercom; a movement-to-standby position control processor that if the information on the intruder's visit is acquired, controls the drive mechanism so that the body will move to a predetermined standby position, that is, a position designated in advance; a human body detector that detects whether there is a human body in the vicinity; and a reporting control processor that instructs the human body detector to keep detecting the presence or absence of a human body at the standby position, and that if a human body is detected, instructs the radiocommunication equipment to report the fact to a predetermined address.

The present invention having the foregoing components includes the drive mechanism that steers and drives the body. The body propels itself to clean a house. Moreover, since the radiocommunication equipment is included, predetermined information can be transmitted or received to or from outside by radio.

In addition to the fundamental abilities, the present invention has other abilities described below. Namely, when the intruder information acquisition processor acquires information on an intruder's visit from the external intercom, the movement-to-standby position control processor controls the drive mechanism so that the body will move to a predetermined standby position. The human body detector detects whether there is a human body in the vicinity. The reporting control processor instructs the human body detector to keep detecting the presence or absence of a human body at the standby position. When the human body detector detects a human body, the reporting control processor instructs the radiocommunication equipment to report the fact to a predetermined address.

Namely, if an intruder is found, the cleaner body moves to the standby position and waits for invasion. If the intruder invades into the house, the body immediately notifies a resident, who is out, of the fact.

In other words, as long as information on an intruder is supplied, if the configuration is slightly modified, the fundamentally owned abilities to propel itself and to communicate with outside are used to defend a house from an intruder.

As a sensor for sensing a human body, any of various types of sensors can be adopted. The human body sensor can be realized with a sensor that senses an infrared-emitting moving object on the basis of a change in an amount of received infrared light. Since infrared light is radiated from the skin or the like of a human body, when an invader emerges, the infrared radiation shifts along with the invader's movement. This causes the amount of infrared light received by the human body sensor to change. Consequently, the human body sensor can sense a human body that is the infrared-emitting moving object.

Radiocommunication to be employed by the radiocommunication equipment is not limited to any specific type of radiocommunication. For example, preferably, the radiocommunication equipment includes a wireless LAN module and transmits or receives information to or from outside via the wireless LAN module.

The wireless LAN module is standardized in terms of both hardware and software and can be adopted inexpensively. Moreover, along with the advancement of wide area networks including the Internet, transmission or reception of information by e-mail is easy to do. This has the merit of requiring installation of no special hardware at a remote destination.

Any of various methods can be adopted as a method of moving the cleaner body to the standby position. Preferably, the movement-to-standby position control processor has a wall sensor, which detects surrounding walls, incorporated in the body. While receiving the result of the detection sent from the wall sensor, the movement-to-standby position control processor controls the drive mechanism so that the body will travel along the walls. The movement-to-standby position control processor acquires positional information from a marker that is disposed along any of the walls and transmits positional information, and thus checks whether the movement to the standby place is completed.

In the above configuration, since the wall sensor that detects surrounding walls is incorporated in the body, the movement-to-standby position control processor receives the result of the detection sent from the wall sensor and controls the drive mechanism so that the body will travel along the walls. On the other hand, when the marker that transmits positional information is located at the standby position by the side of any of the walls, if the body that is traveling along the walls acquires the positional information from the marker, the completion of the movement to the standby position can be recognized with the acquisition of the positional information.

As long as the presence or absence of a wall can be detected, traveling along the walls can be achieved using a relatively small number of hardware devices. For example, traveling along the walls can be achieved with hardware that causes the cleaner body to turn in an appropriate direction when a wall is no longer detected in a certain direction in which the body is moving. However, since a concrete position cannot be specified, a marker is utilized. When a marker is detected during traveling along a wall, the position of the marker may be regarded as the standby position, and the movement of the body is terminated. The marker is not only placed at the final standby position but also designed to transmit information on a guidepost to the final standby position. For example, the marker may be disposed at the entrances of rooms and used to designate whether the cleaner body should enter a room.

Preferably, according to other technique of moving the cleaner body to the standby position, the movement-to-standby position control processor comprises: a mapping processor that while the body propels itself to roam about a room, produces and preserves map information on the interior of the room, and that when the body propels itself within the room, receives predetermined positional information from a marker that is located at a specific position and designed to transmit predetermined positional information, and adds the received information to the map information; a route derivation processor that derives a traveling route starting with a current position and ending with a position designated as the specific position; and a movement control processor that instructs the route derivation processor to derive a traveling route and instructs the drive mechanism to move the body to the specific position along the traveling route.

In the above configuration, when the cleaner body propels itself to roam about a room, the mapping processor produces map information on the interior of the room and preserves it. Moreover, the mapping processor acquires positional information from a marker that is located at a specific position within the room and transmits predetermined positional information, and adds the acquired positional information to the map information. When the standby position is designated as one of the specific positions, the map information contains information on the standby position. The route derivation processor derives a traveling route starting with the current position and ending with a position designated as the specific position, and therefore can naturally derive a traveling route starting with the current position and ending with the standby position. Consequently, the movement control processor instructs the derivation processor to derive the traveling route and instructs the drive mechanism to move the cleaner body to the standby position along the traveling route.

Namely, the fundamental self-propelled cleaning ability of the self-propelled cleaner is utilized, and a marker is used to allow the cleaner body to acquire information on the standby position. Consequently, the body can wait for an intruder at the standby position.

What is performed at the standby position is not limited to detection of the presence or absence of a human body. Preferably, a camera device capable of transmitting photographic image data that represents a produced image is included. When the reporting control processor reports information, the reporting control processor instructs the camera device to produce an image, and instructs the radiocommunication equipment to transmit the photographic image data to a predetermined address.

In the above configuration, when the reporting control processor reports information, the reporting control processor instructs the camera device to produce an image and instructs the radiocommunication equipment to transmit the photographic image data to a predetermined address.

By adding an image to a report, a person having received the report can accurately check whether the report is true. If an intruder emerges, the intruder can be treated immediately.

What is referred to as information on an intruder' visit is not limited to any specific information. A machine cannot make a decision on whether a visitor is an intruder. The conditions for an intruder are predefined. When all the conditions are met, information on an intruder's visit is provided. Preferably, the intercom includes a camera device that images a visitor, stepwise determines the visitor's degree of danger on the basis of the visitor's face imaged by the camera device, and notifies outside of the result of the determination.

In the above configuration, the camera device included in the intercom images a visitor, the visitor's degree of danger is determined stepwise based on the image of the visitor's face, and the external self-propelled cleaner is notified of the result of the determination.

When a visitor's degree of danger is determined based on an image of the visitor's face, images of the faces of visitors who are acquaintances are registered, and an image of a face matched with any of the registered images of faces is recognized not to be dangerous at all. For discrimination of an image of a face, any known technique can be adopted.

Moreover, the easiest way of discriminating information on an intruder's visit is such that while a resident is out, if a visitor merely presses a button included in the intercom, the fact is grasped as information on an intruder's visit. Specifically, the self-propelled cleaner is designed to permit a user to select any of operation modes. A normal cleaning mode as well as a house-sitting mode can be selected. When the house-sitting mode is selected, if the intercom sounds, an intruder's visit is suspected. The cleaner body then stands by at the standby position.

As for the cleaning mechanism included in the body, a suction type cleaning mechanism, a collection type cleaning mechanism using brushes, or a combination thereof may be adopted.

Moreover, the drive mechanism that steers and drives the cleaner body can steer and drive the body so as to advance or withdraw the body, turn the body clockwise or counterclockwise, or spins the body in the same place by controlling the rotations of drive wheels attached to the right and left of the body. In this case, auxiliary wheels may be attached to the front and rear sides of the body respectively. Moreover, the drive mechanism is not limited to the drive wheels but may be realized with endless belts. Otherwise, the drive mechanism may be realized with any structure including four wheels or six wheels.

As a concrete example having the foregoing constituent features, according to one aspect of the present invention, there is provided a self-propelled cleaner being used in combination of an intercom that includes a camera device which images a visitor, that stepwise determines a visitor's degree of danger on the basis of the visitor's face imaged by the camera device, and that notifies outside of the result of the determination, and comprising a body that includes a cleaning mechanism, and a drive mechanism including drive wheels which are attached to the right and left of the body, whose rotations can be controlled independently of each other, and with which the body can be steered and driven. The self-propelled cleaner further comprises: an intruder information acquisition processor that acquires information on an intruder's visit from the intercom; wireless LAN communication equipment that transmits or receives predetermined information to or from outside over a wireless LAN; a mapping processor that while the body propels itself to roam about the room, produces and preserves map information on the interior of a room, and that while the body propels itself within a room, acquires predetermined positional information from a marker, which is located at a specific standby position and designed to transmit predetermined positional information, and adds the positional information to the map information; a route derivation processor that derives a traveling route starting with a current position and ending with the position designated as the standby position; a movement control processor that when the information on an intruder's visit is acquired from the intercom, instructs the route derivation processor to derive a traveling route, instructs the drive mechanism to move the body to the specific position along the traveling route; a human body detector that detects whether there is a human body in the vicinity; a camera device that transmits photographic image data representing a produced image; and a reporting control processor that instructs the human body detector to keep detecting the presence or absence of a human body at the standby position, that instructs the camera device to produce an image, that instructs the wireless LAN communication equipment to report the fact to a predetermined address and to transmit the photographic image data to the predetermined address.

In the above configuration, the intercom includes the camera device that images a visitor, and stepwise determines the visitor's degree of danger on the basis of the visitor's face imaged by the camera device.

The mapping processor included in the self-propelled cleaner acquires and preserves map information on the interior of a room while the body roams about the room so as to clean the room. Moreover, while the body roams about the room, the mapping processor acquires positional information on a standby position from the marker, which is located at a specific position in the room and designed to transmit predetermined positional information, and adds the positional information to the map information. Since the information on the standby position is thus added to the map information, the route derivation processor can derive a traveling route stating with a current position and ending with a position designated as the standby position. The movement control processor instructs the intruder information acquisition processor to acquire the information on an intruder's visit from the intercom, instructs the route derivation processor to derive the traveling route, and instructs the drive mechanism to move the body to the specific position along the traveling route. The human body detector detects whether there is a human body in the vicinity. The reporting control processor instructs the human body detector to keep detecting the presence or absence of a human body at the standby position. If the human body detector detects a human body, the reporting control processor instructs the camera device to produce an image when reporting the fact. Moreover, the reporting control processor instructs the wireless LAN communication equipment to report the fact to a predetermined address and to transmit the photographic image data to the address.

### BRIEF DESCRIPTION OF THE DRAWINGS

FIG. 1 is a block diagram schematically showing the configuration of a self-propelled cleaner in accordance with the present invention;

FIG. 2 is a block diagram showing the self-propelled cleaner in more detail;

FIG. 3 is a block diagram of an AF passive sensor;

FIG. 4 is an explanatory diagram showing the state of a floor attained in a case where the AF passive sensor is oriented obliquely downward with respect to the floor, and a change in a measured distance;

FIG. 5 is an explanatory diagram showing distances in an imaging range that are measured in a case where an immediately preceding position AF passive sensor is oriented obliquely downward with respect to a floor;

FIG. 6 shows positions at which respective AF passive sensors are disposed and points distances to which are measured;

FIG. 7 is a flowchart describing a traveling control sequence;

FIG. 8 is a flowchart describing traveling for cleaning;

FIG. 9 shows a traveling route in a room;

FIG. 10 shows the configuration of an optional unit;

FIG. 11 shows the appearance of a marker;

FIG. 12 is a flowchart describing mapping;

FIG. 13 is an explanatory diagram concerning mapping;

FIG. 14 is an explanatory diagram concerning a technique for joining pieces of map information on rooms after the completion of mapping;

FIG. 15 is a plan view of a house showing the interiors of rooms in which a special position is designated;

FIG. 16 is a block diagram of an intercom;

FIG. 17 is a flowchart describing actions to be performed by a base phone;

FIG. 18 is a flowchart describing intruder treatment;

FIG. 19 is a flowchart describing watch mode;

FIG. 20 shows an operation mode selection display screen image;

FIG. 21 shows a display screen image through which intruder treatment is designated;

FIG. 22 is a perspective view showing another embodiment from the left side of the front thereof; and

FIG. 23 is a perspective view showing the embodiment shown in FIG. 22 from the right side of the back thereof.

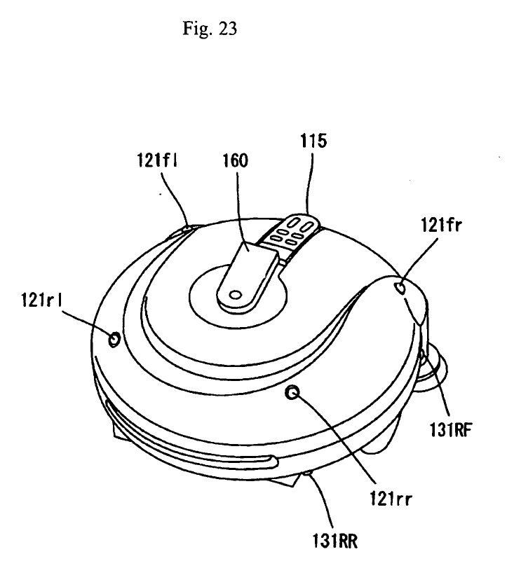

### DESCRIPTION OF THE PREFERRED EMBODIMENTS

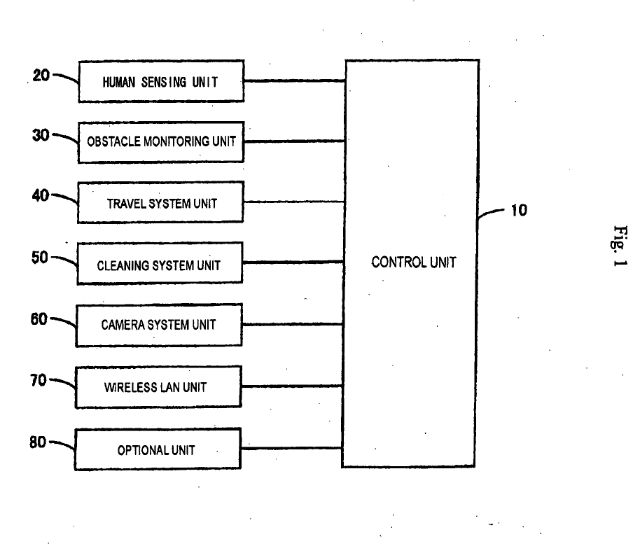

FIG. 1 is a block diagram schematically showing the configuration of a self-propelled cleaner in accordance with the present invention.

As shown in FIG. 1, the self-propelled cleaner comprises: a control unit 10 that controls other units; a human sensing unit 20 that senses whether a human being lies in the vicinity; an obstacle monitoring unit 30 that senses an obstacle located in the vicinity; a traveling system unit 40 that realizes movement; a cleaning system unit 50 that performs cleaning; a camera system unit 60 that images a predetermined range; a wireless LAN unit 70 used for wireless connection of the self-propelled cleaner on a LAN; and an optional unit 80 including an additional sensor. A body BD of the self-propelled cleaner has a thin and substantially cylindrical shape.

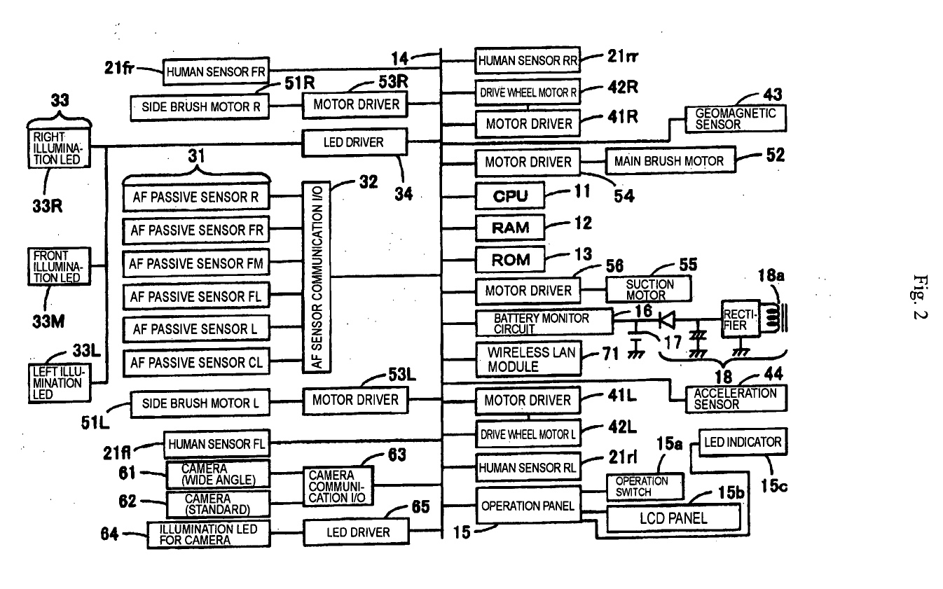

FIG. 2 is a block diagram showing the electrical configuration that realizes the above units in practice.

As the control unit 10, a CPU 11, a ROM 13, and a RAM 12 are interconnected over a bus 14. The CPU 11 uses the RAM 12 as a work area to execute various control sequences according to control programs and various parameter tables stored in the ROM 13. The contents of the control programs will be described later.

An operation panel unit 15 is connected on the bus 14, and comprises various operation switches 15a, a liquid crystal display panel 15b, and LED indicators 15c. The liquid crystal display panel is realized with a monochrome liquid crystal display panel that can display multiple tones. Alternatively, a color liquid crystal display panel will do.

The self-propelled cleaner includes a battery 17, and the CPU 11 can monitor the remaining battery capacity of the battery 17 via a battery monitor circuit 16. The battery 17 includes a charge circuit 18 that charges the battery using power supplied in a non-contact manner via an induction coil 18a. The battery monitor circuit 16 mainly monitors the voltage at the battery 17 so as to sense the remaining battery capacity.

As the human sensing unit 20, four human sensors 21 (21fr, 21rr, 21fl, and 21rl) are disposed to face in obliquely right and left forward directions and in obliquely right and left backward directions. The human sensors 21 include an infrared light receiving sensor and sense the presence or absence of a human body on the basis of a change in an amount of received infrared light. When an object that radiates varying infrared light is sensed, a transmitting state of a human sensor is changed. The CPU 11 can acquire the results of sensing sent from the human sensors 21 over the bus 14. In other words, the CPU 11 checks the states of the human sensors 21fr, 21rr, 21fl, and 21rl at intervals of a predetermined time. If the state of any of the human sensors 21fr, 21rr, 21fl, and 21rl is changed, the presence of a human body is sensed in a direction in which the human sensor is facing.

Herein, the human sensor is realized with a sensor that is sensitive to a change in an amount of infrared light. The present invention is not limited to this type of sensor. For example, if the throughput of the CPU is improved, a color image may be produced in order to check the size of a skin-colored area, which renders a feature of a human body, or a change in the area. A human body may be sensed based on the size of the skin-colored area or the change in the area.

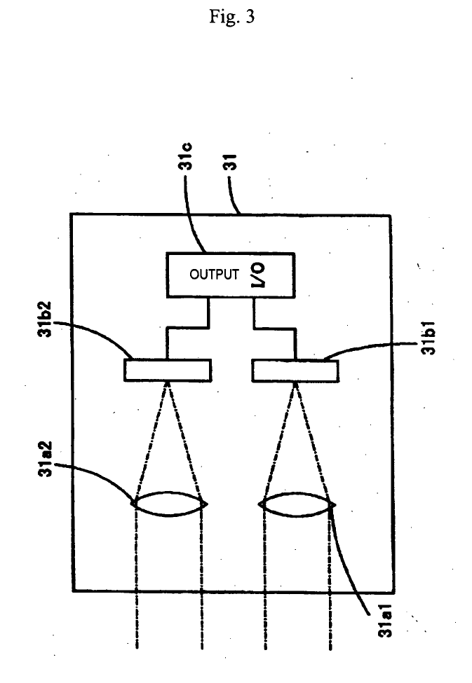

The obstacle monitoring unit 30 comprises AF passive sensors 31 (31R, 31FR, 31FM, 31FL, 31L, and 31CL) serving as range-finding sensors for automatic focusing (AF), an AF sensor communication input/output (I/O) circuit 32 serving as a communication interface, illumination LEDs 33, and an LED driver 34 that supplies a driving current to the LEDs. To begin with, the configuration of the AF passive sensors 31 will be described. FIG. 3 schematically shows the configuration of the AF passive sensors 31. Each of the AF passive sensors 31 comprises optical systems 31a1 and 31a2 whose optical axes are parallel to each other, CCD line sensors 31b1 and 31b2 disposed nearly at the positions of the image planes of the optical systems 31a1 and 31a2, and a transmission I/O circuit 31c that transmits photographic image data produced by the CCD line sensors 31b1 and 31b2 to outside.

The CCD line sensors 31b1 and 31b2 are realized with a CCD sensor that offers 160 to 170 pixels, and can transmit data of 8 bits long, which represents an amount of light, for each pixel. Since two optical systems are included, images formed by the optical systems are deviated from each other according to a distance to an object. The distance can be measured based on a disagreement between data items transmitted from the respective CCD line sensors 31b1 and 31b2. For example, as the object is located at a shorter distance, the deviation of one of the formed images from the other gets larger. As the object is located at a longer distance, the deviation of one of the formed images to the other approaches nil. Consequently, data sent from one of the CCD line sensors is scanned in units of a data stream representing four or five pixels. A difference of the pixel locations represented by the detected data stream from those represented by the original data stream is calculated, and a difference-to-distance conversion table stored in advance is referenced based on the difference in order to retrieve an actual distance.

Among the AF passive sensors 31R, 31FR, 31FM, 31FL, 31L, and 31CL, the AF passive sensors 31FR, 31FM, and 31FL are used to sense an obstacle located in front of the cleaner body. The AF passive sensors 31R and 31L are used to sense an obstacle located immediately ahead of the right or left side of the front of the cleaner body, and the AF passive sensor 31CL is used to sense a distance to the ceiling in the forward direction.

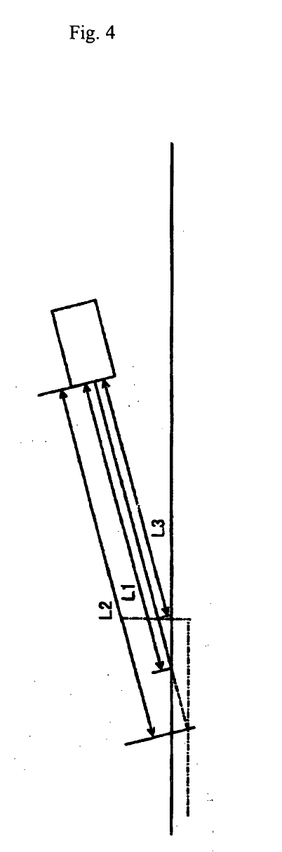

FIG. 4 shows the principles of sensing of an obstacle, which is located in front of the cleaner body or immediately ahead of the right or left side of the front of the cleaner body, performed by the AF passive sensors 31. The AF passive sensors 31 are disposed obliquely with respect of the surrounding floor. If no obstacle is present in a direction in which any of the AF passive sensors is facing, the distance to be measured by the AF passive sensor 31 is a distance L1 relative to a nearly entire imaging range covered by the sensor. However, if there is a step as indicated with a dot-dash line in the drawing, the distance to be measured thereby is a distance L2. Therefore, if the measured distance is increased, the presence of a step is recognized. If there is an ascending step as indicated with an alternate long and two short dashes line, the distance to be measured thereby is a distance L3. When an obstacle is present, similarly to when the ascending step is present, the distance to be measured is measured as a distance to the obstacle and is shorter than the distance to the floor.

According to the present embodiment, when the AF passive sensors 31 are oriented obliquely forward with respect to the floor, the imaging range covered by each of the sensors is approximately 10 cm long. Since the width of the self-propelled cleaner is 30 cm, the three AF passive sensors 31FR, 31FM, and 31FL are disposed at slightly different angles for fear the imaging ranges covered by the respective sensors may overlap. Consequently, an obstacle and a step located within a range of 30 cm wide in the forward direction can be sensed by the three AF passive sensors 31FR, 31FM, and 31FL. The width of the range within which an obstacle or a step can be sensed varies depending on the specifications for the sensors or the positions at which the sensors are disposed. The number of sensors to be employed depends on the width of the range actually required.

On the other hand, the AF passive sensors 31R and 31L to be used to sense an obstacle located immediately ahead of the right or left side of the front of the cleaner body are disposed so that their imaging ranges will spread obliquely with respect to the floor with a vertical direction as a reference. Moreover, the AF passive sensor 31R is mounted on the left flank of the cleaner body in order to image a right-hand range which extends from a position immediately preceding the right flank of the cleaner body beyond the center of the cleaner body and whose width exceeds the width of the cleaner body. The AF passive sensor 31L is mounted on the right flank of the cleaner body in order to image a left-hand range which extends from a position immediately preceding the left flank of the cleaner body beyond the center of the cleaner body and whose width exceeds the width of the cleaner body.

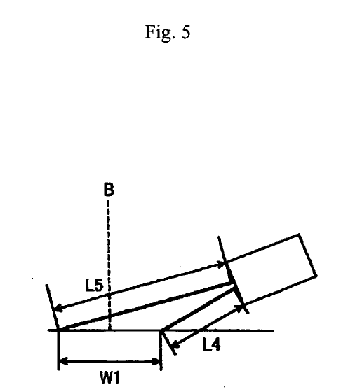

If the AF passive sensors 31R and 31L are not disposed to face in crossing directions but disposed to image an object at a position immediately preceding the right or left flank of the cleaner body, the sensors must be opposed to a floor at an acute angle. In this case, an imaging range covered by each of the sensors becomes very narrow. Consequently, a plurality of sensors is necessary. Therefore, the AF passive sensors are intentionally disposed to face in the crossing directions so that they can cover a wide imaging range. Thus, a small number of sensors is used to cover a required range. Moreover, when the AF passive sensors are disposed so that their imaging ranges will spread obliquely with a vertical direction as a reference, it means that the direction in which the CCD line sensors are juxtaposed is aligned with the vertical direction. The width of each of the imaging ranges is, as shown in FIG. 5, a width W1. The distance L4 to the floor at the right edge of each of the imaging ranges is short, and the distance L5 thereto at the left edge thereof is long. Assuming that a dot line B indicates the boundary of the flank of the body BD, a portion of the imaging range ending with the boundary is used to sense a step, and the other portion thereof starting with the boundary is used to sense the presence or absence of a wall.

The AF passive sensor 31CL to be used to sense the distance to the ceiling in the forward direction is facing the ceiling. Normally, the distance from the floor to the ceiling to be sensed by the AF passive sensor 31CL remains constant. As the cleaner body approaches a wall, the imaging range to be covered by the AF passive sensor is not a range on the ceiling but a range on the wall. Therefore, a distance to be measured gets shorter. Consequently, the presence of a wall in the forward direction can be sensed more accurately.

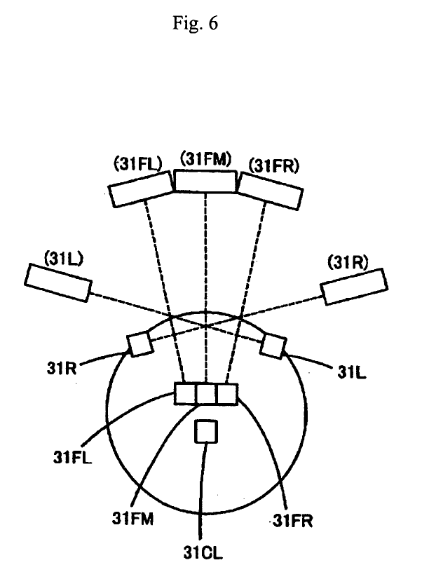

FIG. 6 shows the positions on the body BD at which the AF passive sensors 31R, 31FR, 31FM, 31FL, 31L, and 31CL are disposed. Reference numerals in parentheses indicate the imaging ranges on the floor to be covered by the respective sensors. Incidentally, an imaging range on the ceiling is not shown.

A right illumination LED 33R, a left illumination LED 33L, and a front illumination LED 33M that are realized with white LEDs are included in order to guarantee imaging by the AD passive sensors 31R, 31FR, 31FM, 31FL, and 31L. The LED driver 34 supplies a driving current in response to a control instruction sent from the CPU 11, and thus enables illumination. Consequently, even at night or even when the cleaner body is located under a table or any other dark place, effective image data can be acquired from the AF passive sensors 31.

The traveling system unit 40 comprises motor drivers 41R and 41L, drive wheel motors 42R and 42L, and a gear unit and drive wheels that are not shown but are driven by the drive wheel motors 43R and 43L. The drive wheels are disposed on the right and left flanks respectively of the body BD. In addition, a freely rotating drive wheel devoid of a driving source is disposed in the center of the front lower side of the body. The drive wheel motors 42R and 42L have the directions and angles of rotation thereof finely regulated by motor drivers 41R and 41L respectively. The motor drivers 41R and 41L transmit a driving signal associated with a control instruction sent from the CPU 11. Moreover, the actual directions and angles of rotation of the drive wheels can be accurately sensed based on outputs of rotary encoders mounted as integral parts of the drive wheel motors 42R and 42L respectively. The rotary encoders may not be directly coupled to the drive wheels, but freely rotating driven wheels may be disposed near the drive wheels in order to feed back magnitudes of rotation made by the respective driven wheels. Thus, even when the drive wheels are skidding, the actual magnitudes of rotation of the drive wheels can be sensed. The traveling system unit 40 further comprises a geomagnetic sensor 43, whereby a traveling direction is checked based on geomagnetism. Moreover, the acceleration sensor 44 senses accelerations in three directions of X, Y, and Z axes, and transmits the results of the sensing.

Any of various kinds of gear units or drive wheels can be adopted. Alternatively, circular rubber tires may be driven, or an endless belt may be driven.

The cleaning mechanism included in the self-propelled cleaner comprises side brushes disposed on the right and left sides of the front of the body BD in order to collect dust or the like from near the right and left flanks of the body into near the center of the body BD, a main brush used to scoop up the dust collected near the center of the body, and a suction fan that sucks the dust scooped up by the main brush so as to put it in a dust box. The cleaning system unit 50 comprises side brush motors 51R and 51L and a main brush motor 52 which drive the respective brushes, motor drivers 53R, 53L, and 54 that supply driving power to the respective motors, a suction motor 55 that drives the suction fan, and a motor driver 56 that supplies driving power to the suction motor. Cleaning to be performed using the side brushes and main brush is appropriately controlled by the CPU 1 according to the situation of a floor or the battery or a user-specified instruction.

The camera system unit 60 includes two CMOS cameras 61 and 62 that offer different viewing angles and that are mounted at different elevations to face in front of the body BD. Moreover, the camera system unit 60 includes a camera communication I/O circuit 63 that instructs the cameras 61 and 62 to image an object and transmits a produced image. Furthermore, the camera system unit 60 includes camera illumination LEDs 64 that are realized with fifteen white LEDs and are facing in a direction of imaging to be performed by the cameras 61 and 62, and an LED driver 65 that supplies illumination driving power to the LEDs 64.

The wireless LAN unit 70 includes a wireless LAN module 71. The CPU 11 can access an external LAN by radio according to a predetermined protocol. Assuming that an access point that is not shown exists, the wireless LAN module 71 can access the access point via a router or the like over an external wide area network (for example, the Internet). Consequently, a normal e-mail message can be transmitted or received over the Internet or a Web site can be browsed over the Internet. The wireless LAN module 71 comprises a standardized card slot and a wireless LAN card that is standardized and loaded in the slot. Needless to say, any other standardized card may be loaded in the card slot. According to the present embodiment, an e-mail message can be transmitted or received over the Internet. When an e-mail message is externally transmitted, the email message can be received over the Internet and wireless LAN. When the contents of an e-mail message are interpreted, if an electronically unlocked command is contained, the command is executed.

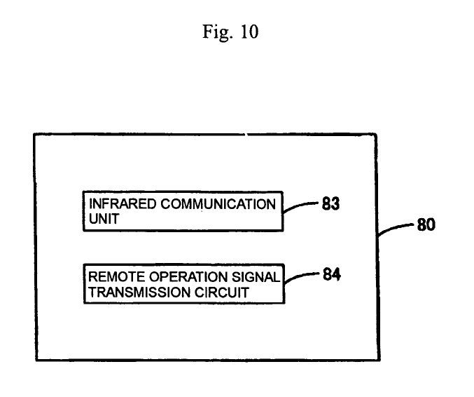

The optional unit 80 includes, as shown in FIG. 10, an additional sensor. According to the present embodiment, the optional unit 80 includes an infrared communication unit 83 and a microphone unit 84. The infrared communication unit 83 can receive an infrared signal produced by encoding positional information sent from a marker that will be described later. The infrared communication unit 83 decodes the positional information and transmits it to the CPU 11.

The microphone unit 84 digitizes sounds and transmits the resultant data over the bus 14. The CPU 11 records in advance data produced by digitizing a ringing code of a base phone included in the intercom that is not shown. When the intercom rings, the microphone unit 84 digitizes the ring, collates the resultant data with the recorded data, and thus checks whether the intercom has rung.

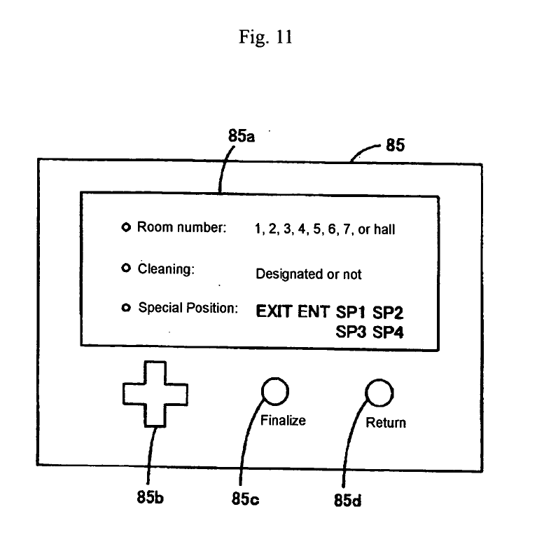

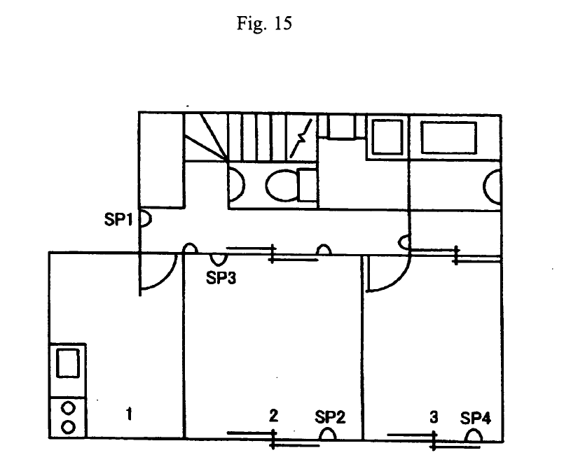

FIG. 11 shows the appearance of a marker 85. The marker 85 externally comprises a liquid crystal display panel 85a, a cross key 85b, a Finalize key 85c, and a Return key 85d, and internally comprises a one-chip microcomputer, an infrared transmission/reception unit, and a battery. The one-chip microcomputer controls display on the liquid crystal display panel 85a responsively to manipulations performed on the Finalize key 85c and Return key 85d respectively, and produces a setting parameter responsively thereto. The one-chip microcomputer transmits positional information associated with the setting parameter using the infrared transmission/reception unit. According to the present embodiments, settings to be determined include a room number for which any of numerals 1 to 7 and a hall can be specified, whether or not cleaning is designated, and a special position for which any of an exit, an entrance, a special position 1 (SP1), a special position 2 (SP2), a special position 3 (SP3), and a special position 4 (SP4) can be specified. In the embodiments described below, the special position 1 shall be a position in a room 1, the special position 2 shall be a position in a room 2, the special position 3 shall be a position in a hall, and the special position 4 shall be a position at which the base phone included in the intercom is disposed. A flowchart describing determination of the settings is not a special one but can be produced with an ordinary knowledge by any person with an ordinary skill in the art. FIG. 15 shows the layout of the special positions 1 to 4.

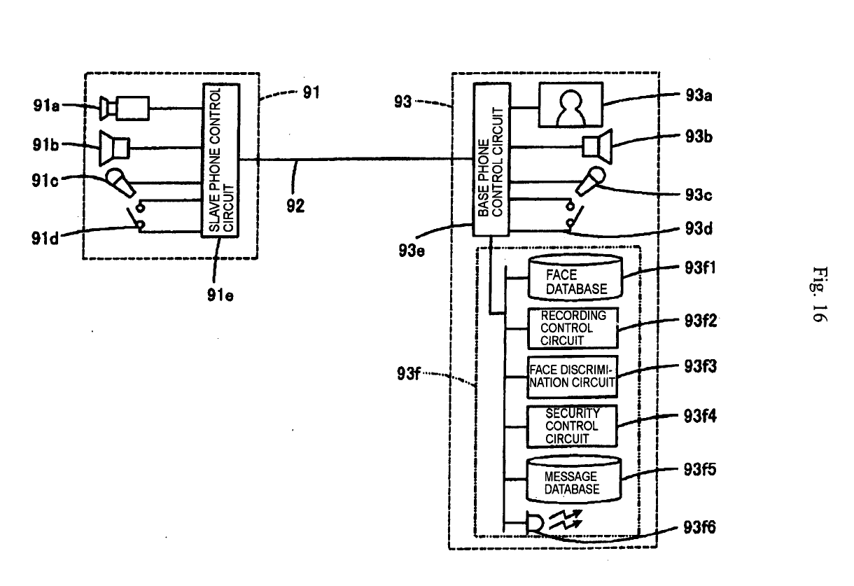

FIG. 16 shows the hardware configuration of the intercom. A slave phone 91 includes a camera device 91a that images a visitor's face, a loudspeaker 91b that reproduces sounds sent from the base phone, a microphone 91c that collects sounds through the slave phone, and operation switches 91d used to manipulate the slave phone which are connected to a slave phone control circuit 91e. The slave phone 91 is connected to a base phone 93 over a communication line 92. The base phone 93 comprises a display 93a on which the visitor's face is displayed, a loudspeaker 93b that reproduces sounds sent from the slave phone, a microphone 93c that collects sounds through the base phone, and an operation switch 93d to be manipulated in order to use the base phone. These components of the base phone are connected to a base phone control circuit 91e.

The base phone 93 originally functions using the above components. According to the present embodiment, the base phone 93 further comprises a house-sitting unit 93f that is an optional unit. The house-sitting unit 93f comprises a face database 93f1 that is a database in which images of visitors'faces are recorded, a recording control circuit 93f2 that controls recording of an image of a visitor produced by the camera device 91a, a face discrimination circuit 93f3 that collates a visitor's image with the data recorded in the face database 93f1 so as to discriminate the face, a security control circuit 93f4 that guarantees phased security according to the result of the discrimination performed by the face discrimination circuit 93f3, a message database 93f in or from which an audio signal representing sounds is recorded or reproduced, and an infrared communication unit 93f6 that transmits a signal using general-purpose infrared light. When the security control circuit 93f4 guarantees phased security, the infrared communication unit 93f6 transmits a signal to the infrared communication unit 83.

Next, actions to be performed by the self-propelled cleaner having the foregoing components will be described below.

(1) Traveling Control and Cleaning

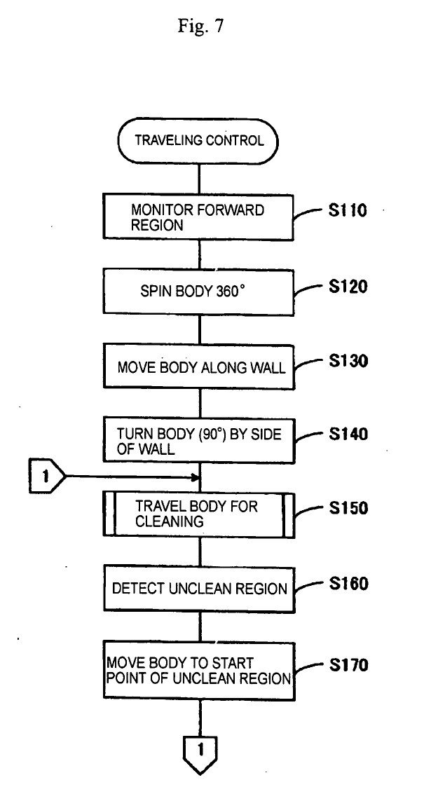

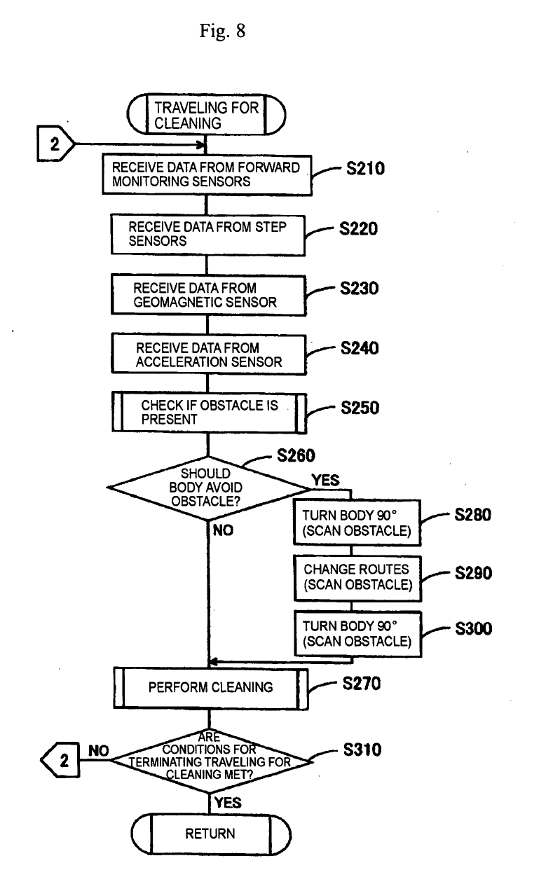

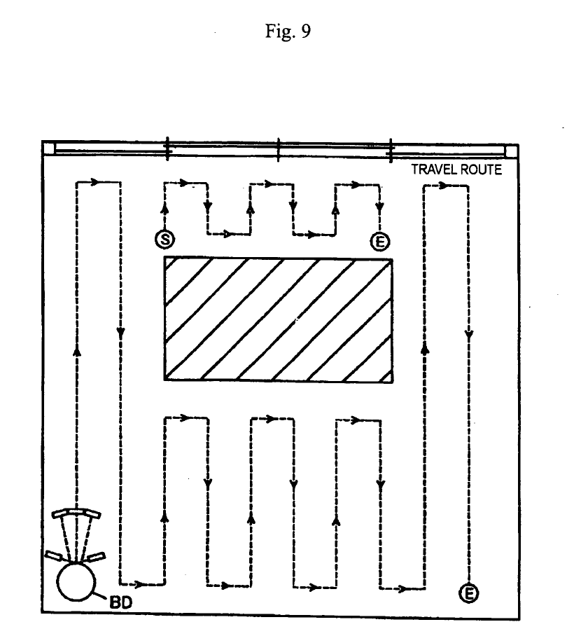

FIG. 7 and FIG. 8 are flowcharts describing steps corresponding to those described in a control program to be run by the CPU 11. FIG. 9 shows a traveling route along which the self-propelled cleaner travels according to the control program.

When the power supply is turned on, the CPU 11 initiates a sequence of traveling control described in FIG. 7. At step S110, the results of sensing sent from the AF passive sensors 31 are received and a forward region is monitored. The results of sensing sent from the AF passive sensors 31FR, 31FM, and 31FL are used to monitor the forward region. If the forward region is a region on a flat floor, the distance L1 to the floor located obliquely downward is detected based on each of images produced by the sensors. Based on the results of sensing sent from the AF passive sensors 31FR, 31FM, and 31FL, the forward region on the floor whose width corresponds to the width of the body BD is checked to see if it is flat. However, at this time, since information on a region between a position on the floor to which each of the AF passive sensors 31FR, 31FM, and 31FL is facing and a position immediately preceding the body is not acquired at all, the region is a blind spot.

At step S120, the CPU 11 instructs the drive wheel motors 42R and 42L via the motor drivers 41R and 41L to drive the respective drive wheels in different directions of rotation by the same magnitude of rotation. This causes the body BD to start turning in the place where the body lies. The magnitude of rotation by which the drive wheel motors 42R and 42L must rotate so as to cause the body to make a 360° turn (a spin) in the place is already known. The CPU 11 instructs the motor drivers 41R and 41L to drive the drive wheel motors by the magnitude of rotation.

While the body is spinning, the CPU 11 receives the results of sensing sent from the AF passive sensor 31R and 31L so as to check the situation at the position immediately preceding the body BD. The aforesaid blind spot is almost eliminated owing to the results of sensing. If neither a step nor an obstacle is present, the presence of the flat floor in the vicinity is sensed.

At step S130, the CPU 11 instructs the drive wheel motors 42R and 42L via the motor drivers 41R and 41L to drive the respective drive wheels by the same magnitude of rotation. This causes the body BD to start moving rectilinearly. While the body is moving rectilinearly, the CPU 11 receives the results of sensing sent from the AF passive sensors 31FR, 31FM, and 31FL so as to check whether an obstacle is found in front. If a wall that is the obstacle is sensed in front according to the results of sensing, the body is halted at a predetermined distance away the wall.

At step 140, the body is turned 90° clockwise. The body is halted at a predetermined distance away from the wall at step S130. The predetermined distance falls within a range of values that prevent the body BD from colliding against the wall when making a turn or that allow the AF passive sensor 31R or 31L, which helps check the situation at an immediately preceding position or a right-hand or left-hand position, to sense a position outside the width of the body. Namely, the body is halted based on the results of sensing sent from the AF passive sensors 31FR, 31FM, and 31FL at step S130. When the body is turned 90° at step S140, the predetermined distance is a distance permitting at least the AF passive sensor 31L to sense a position on the wall. Moreover, when the body is turned 90° the situation at an immediately preceding position is checked based on the results of sensing sent from the AF passive sensors 31R and 31L. FIG. 9 is a plan view showing a scene where the cleaner body starts traveling for cleaning with the left lower corner of a room in the drawing, where the cleaner body has reached as mentioned above, regarded as a cleaning start position.

A procedure for enabling the cleaner body to reach the traveling-for-cleaning start position is not limited to the above procedure but various methods are conceivable. When the body almost abuts against a wall, if the body is merely turned 90° clockwise, the body may have to start traveling from a middle point in the width of an initial wall. Therefore, in order to enable the body to reach an optimal position at the left lower corner shown in FIG. 9, the body is preferably turned 90° counterclockwise when abutting on a wall. Thereafter, the body is advanced until it abuts on a front wall, and then turned 180°.

At step S150, traveling for cleaning is performed. FIG. 8 is a flowchart describing traveling for cleaning in more detail. Prior to advancement, the results of sensing sent from various sensors are received at steps S210 to S240. At step S210, data is received from the forward monitoring sensors. Specifically, the results of sensing sent from the AF passive sensors 31FR, 31FM, 31FL, and 31CL are received in order to check whether an obstacle or a wall exist ahead of a traveling range. What is referred to as forward monitoring broadly includes monitoring of the ceiling.

At step S220, data is received from the step sensors. Specifically, the results of sensing sent from the AF passive sensors 31R and 31L are received in order to check whether a step is found at a position immediately preceding the traveling range. Moreover, when the cleaner body travels in parallel with a wall or an obstacle, the distance to the wall or obstacle is measured in order to check whether the body is moving in parallel.

At step S230, data is received from the geomagnetic sensor. Specifically, the result of sensing sent from the geomagnetic sensor 43 is received in order to check whether a traveling direction is changed during rectilinear traveling. For example, an angle of geomagnetism measured at the start of traveling for cleaning is preserved. If an angle detected during traveling is different from the preserved angle, the magnitudes of rotation by which the right and left drive wheel motors 42R and 42L are rotated are slightly changed in order to correct a moving direction. Thus, the original angle of geomagnetism is restored. For example, when the angle of geomagnetism changes to increase (a change from 359° to 0° is exceptional), the trajectory the cleaner body has traced must be corrected leftward. Consequently, a drive control instruction is issued to the motor drivers 41R and 41L so that the magnitude of rotation of the right drive wheel motor 42R will be slightly larger than the magnitude of rotation of the left drive wheel motor 42L.

At step S240, data is received from the acceleration sensor. Specifically, the result of sensing sent from the acceleration sensor 44 is received in order to check a traveling state. For example, if an acceleration in substantially one direction is sensed at the start of rectilinear traveling, the traveling is recognized to be normal. If an acceleration in a varying direction is sensed, an abnormality that one of the drive wheel motors is not driven is recognized. Moreover, if an acceleration value exceeds a normal range of values, an abnormality that the cleaner body has fallen from a step or the like or has rolled is recognized. If a large acceleration in a backward direction is sensed during advancement, an abnormality that the cleaner body has abutted against a forward obstacle is recognized. Thus, an acceleration value is effectively utilized in order to detect an abnormality but not used to maintain a target acceleration, to calculate a speed based on an integration value of received acceleration values, or to directly control traveling.

At step S250, the presence or absence of an obstacle is determined based on the results of sensing sent from the AF passive sensors 31FR, 31FM, 31CL, 31FL, 31R, and 31L which are received at steps S210 and S220. Determination of the presence or absence of an obstacle is performed for each of regions such as a front region, a ceiling, and an immediately forward region. The front region is checked to see if an obstacle or a wall is found. The immediately forward region is checked to see if a step is found, and to see what is the situation on the right and left sides of a traveling range, for example, to see if a wall is found. Even when no obstacle is found in front, if the distance to a ceiling gets shorter because of a door lintel or the like, it is checked that a hall extends from below the door lintel outside a room.

At step S260, the results of sensing sent from the respective sensors are comprehensively checked to see if the cleaner body should avoid an obstacle or a wall. As long as the cleaner body need not avoid an obstacle or a wall, cleaning of step S270 is executed. The cleaning is to suck dust by rotating the side brushes and main brush. Specifically, an instruction that the motors 51R, 51L, 52, and 55 should be driven is issued to the motor drivers 53R, 53L, 54, and 56 respectively. While the cleaner body is traveling, the instruction is always issued. The issuance is not ceased until the conditions for terminating traveling for cleaning are met as described later.

On the other hand, if the necessity of avoiding an obstacle or a wall is recognized, the cleaner body is turned 90° clockwise at step S280. The turn is a 90° turn to be made in one place. The drive wheel motors 42R and 42L are instructed via the motor drivers 41R and 41L to drive the respective drive wheels in different directions of rotation by magnitudes of rotation permitting the 90° turn. The direction of rotation in which the right drive wheel should be rotated is a direction of withdrawal, while the direction of rotation in which the left drive wheel should be rotated is a direction of advancement. While the drive wheels are rotated, the results of sensing sent from the AF passive sensors 31R and 31L serving as step sensors are received in order to check the situation of an obstacle. For example, assume that an obstacle is sensed in front and that the cleaner body is turned 90° clockwise. In this case, unless the AF passive sensor 31R senses a wall at a position immediately preceding the right front side of the cleaner body, the cleaner body may abut against the wall lies in front. If the wall is sensed at the position immediately preceding the right front side of the cleaner body even after the body makes the turn, the cleaner body is considered to have come to a corner of a room or the like. Moreover, while the cleaner body is rotating 90° clockwise, as long as neither the AF passive sensor 31R nor 31L senses an obstacle located immediately ahead, the cleaner body is considered to have abutted against a small obstacle rather than a wall.

At step S290, the cleaner body advances to change routes while scanning an obstacle. The cleaner body abuts against a wall, turns 90° clockwise, and then advances. If the cleaner body halts in front of a wall, the magnitude of advancement is equivalent to the width of the cleaner body BD. At step S300, the cleaner body turns 90° clockwise again so as to cancel out the advancement.

While the cleaner body is moving as mentioned above, a region in front of the body or a region on the right or left side of the front of the body is always scanned in order to see if there is an obstacle in the region. Information on the presence or absence of an obstacle in a room is preserved.

In the above description, the 90° clockwise turn is performed twice. When a wall is sensed forward, if the 90° clockwise turn is repeated, the cleaner body is oriented to face in the previous direction. The two 90° turns alternately change from two 90° clockwise turns to two 90° counterclockwise turns, and so on. Consequently, the cleaner body turns clockwise so as to avoid an odd-numbered obstacle, and turns counterclockwise so as to avoid an even-numbered obstacle.

While the cleaner body is avoiding an obstacle as mentioned above, the cleaner body travels zigzag within a room so as to proceed with cleaning. At step S310, whether the cleaner body has come to an end of the room is checked. Traveling for cleaning is terminated in a case where after the cleaner body makes two turns, it advances along a wall to proceed with cleaning and then senses an obstacle forward, or a case where the cleaner body enters a region in which it has already traveled. In other words, the former is a condition for termination that will be met after the cleaner body travels from one end of a room, to which it has reached through zigzag traveling, to another end thereof. The latter is a condition for termination that will be met when an unclean region is discovered as described later. In this case, traveling for cleaning is restarted.

Unless either of the conditions for termination is met, processing is resumed from step S210. If either of the conditions for termination is met, the traveling-for-cleaning subroutine is terminated, and processing described in FIG. 7 is resumed.

After the processing is resumed, the traveling route along which the cleaner body has traveled and the situation in the surroundings are checked to see if an unclean region remains. If an unclean region is found, the cleaner body moves to the start point of the unclean region at step S170. Traveling for cleaning is restarted from step S150.

Even if a plurality of unclean regions is scattered, every time either of the conditions for termination of traveling for cleaning is met, detection of an unclean region is repeated. Finally, an unclean region becomes unfound.

(2) Mapping

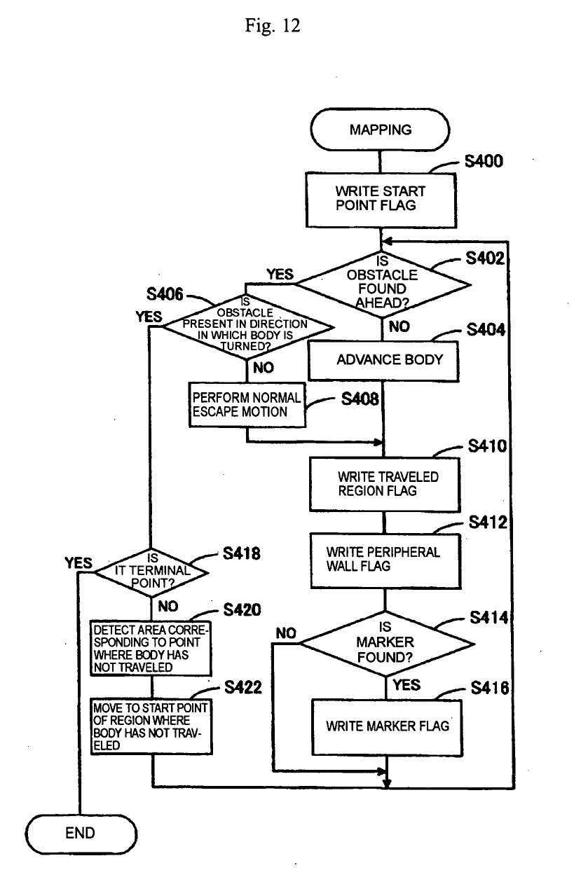

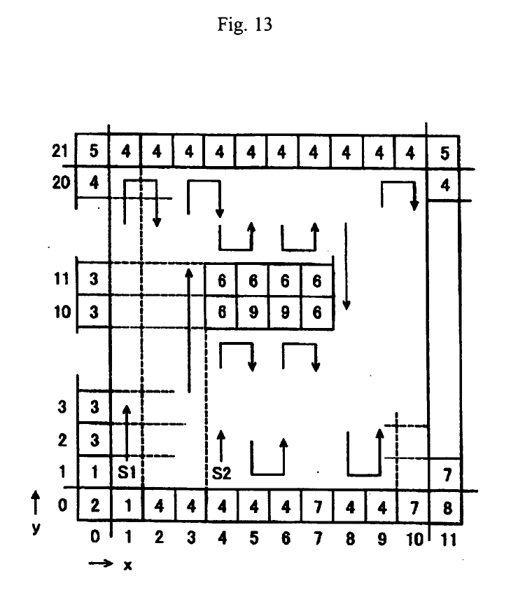

Checking the presence or absence of an unclean region can be achieved according to any of various techniques. The present embodiment adopts a mapping technique described or shown in FIG. 12 or FIG. 13.

FIG. 12 is a flowchart describing mapping, while FIG. 13 is an explanatory diagram concerning the mapping technique. In this example, based on the results of sensing sent from the aforesaid rotary encoders, a traveling route in a room and whether a wall has been detected during traveling are written in a map preserved in a storage area. Whether surrounding walls are continuous but not intermittent, whether the perimeter of an obstacle present in a room is continuous, and whether the cleaner body has traveled throughout a range in the room other than a place where an obstacle is present are checked in order to determine the presence or absence of an unclean region.

A mapping database is a two-dimensional database in which any address can be accessed with an x-coordinate and a y-coordinate. An area represented by coordinates (1,1) shall be a start point that is a corner of a room. An area represented by coordinates (n,0) or (0,m) is a point on a wall. A unit area shall be regarded as a square point of 30 cm by 30 cm wide corresponding to the size of the body BD. The interior of a room is mapped by distinguishing an untraveled point, a cleaned point, a wall, or an obstacle.

At step S400, a start point flag is written. As shown in FIG. 13, the start point (1,1) is a corner of a room. The cleaner body spins 360°, and confirms that a wall is found backward and leftward. A wall flag (1) is written in the associated unit areas (1,0) and (0,1), and the wall flag (2) is also written in an area (0,0) in which the walls meet. At step S402, whether an obstacle is found ahead of the body BD is checked. If no obstacle is found ahead, the cleaning body advances only a distance equivalent to the unit area. The advancement is accompanied by cleaning as described previously. Specifically, while the cleaner body is moving to clean the room, when the cleaner body has moved the distance equivalent to the unit area according to the outputs of the rotary encoders, the mapping is performed concurrently.

On the other hand, if an obstacle is found ahead, a direction in which the cleaner body is turned is checked to see if an obstacle is found in that direction at step S406. In order to avoid an obstacle, a 90° turn, advancement, and a 90° turn are performed in that order. As for the direction of a turn, two clockwise turns and two counterclockwise turns are repeatedly alternated as described above. Assuming that the turns to be made in order to avoid an obstacle are clockwise turns, if an obstacle is found ahead, whether the cleaner body can advance rightward and then makes a turn is checked. In an early stage, an unclean region spreads rightward. No obstacle is thought to lie in a direction in which the cleaner body turns. At step S408, a normal avoiding motion is performed.

After the above movements are made, a traveled region flag is written in unit areas, which are associated with points on a route along which the cleaner body has traveled, at step S410. When it says that the cleaner body has traveled, it means that the cleaner body has cleaned a specific portion of a room. A flag indicating a cleaning completed region is written in the unit areas. At step S412, a surrounding wall flag is written in the unit areas in order to indicate the situation of the surrounding walls. When the cleaner body moves from a point corresponding to the unit area (1,1) to a point corresponding to the unit area (1,2), whether a wall is present at points corresponding to unit areas (0,1) and (2,1) can be checked based on the results of sensing sent from the AF passive sensors 31R and 31L. A flag indicating a wall is written in the unit area (0,1), and a flag indicating that no wall is found, that the cleaner body has not traveled, and that the cleaner body has not cleaned is written in the unit area (2,1).

On the other hand, an obstacle is detected ahead at a point corresponding to a unit area (1,20). The cleaner body then makes two 90° turns and advances to a point corresponding to a unit area (2,20). The moving direction is reversed 180°. At this time, a flag (4) is written in each of the unit areas (0,20), (2,20), (1,21), and (2,21). Moreover, since the unit area (0,21) corresponds to a point at which the walls meet, a flag (5) indicating a wall is written in the unit area. A point where the cleaner body has already traveled and cleaned is regarded as an obstacle.

When the cleaner body advances, an obstacle is sensed rightward at positions corresponding to unit areas (3,10) and (3,11). At this time, an obstacle flag (6) is written in the unit areas. When the cleaner body moves from a point corresponding to a unit area (3,1) to a point corresponding to a unit area (3,9), points where the cleaner body has not traveled and it has not cleaned are detected on the right side of the moving direction. A flag indicating that the cleaner body has not traveled and that it has not cleaned is written in corresponding unit areas. Likewise, when the cleaner body moves from a point corresponding to a unit area (8,9) to a point corresponding to a unit area (8,1), points where the cleaner body has not traveled and it has not cleaned are sensed on the right side of the moving direction. The flag indicating that the cleaner body has not traveled and that it has not cleaned is written in corresponding unit areas.

At a point corresponding to a unit area (4,12), the cleaner body senses an obstacle ahead and makes an avoiding motion. At this time, the obstacle flag has already been written in the unit area (4,11). Along with movement, the obstacle flag is written in the unit area (4,11).

At step S414, whether positional information is received from the marker 85 at a point where the cleaner body has traveled is checked. If the cleaner body has communicated with the marker, a flag based on the information received from the marker is written in the unit area corresponding to the point at step S416. For example, assume that a user manipulates the operation keys 85b to 85d of the marker 85 so as to place the marker 85 at a specific point for the purpose of designating an escape gate. When the cleaner body BD passes the specific point, the cleaner body uses the infrared communication unit 83 to acquire positional information. Consequently, a flag indicating the escape gate is written in the unit area corresponding to the specific point.

Advancement and an avoiding motion are repeated, whereby an obstacle is discovered on the left side of a moving direction at a point corresponding to a unit area (10,20). In this case, the point corresponding to the unit area (10,20) is thought to lie on a continuous wall. A flag (4) indicating a wall is therefore written in the unit area (11,20). The flag (5) indicating a wall is also written in a unit area (11,21) corresponding to a point at which walls meet.

As a result of the repetition of the advancement and avoiding motion, an obstacle is discovered ahead at a point corresponding to a unit area (10,1). Moreover, an obstacle is thought to lie in a direction in which the cleaner body is turned. Consequently, whether the point is a terminal point is checked at step S418. At the point corresponding to the unit area (10,1), not only the obstacle is found ahead but also a wall is found on the left side of a moving direction (7)(8).

The primary criterion for checking whether a point is a terminal point is to check whether there is a unit area in which a flag indicating that the cleaner body has not traveled and a flag indicating that the cleaner body has not cleaned are written. If the unit area in which the flag indicating that the cleaner body has not traveled and that it has not cleaned is written becomes unfound, whether the wall flag written in the unit area corresponding to the start point is found continuously circumferentially is checked. If the wall flag is found continuously circumferentially, the room is scanned in an X direction and a Y direction in order to search points corresponding to unit areas in which no flag is written. As for points recognized as an obstacle, they are checked to see if they lie continuously in the same manner as walls. If the points lie continuously, detection of an obstacle is completed.

If a point is recognized not to be a terminal point, a unit area in which a flag indicating that the cleaner body has not traveled is written is detected at step S420. At step S422, the foregoing processing is restarted from the start point corresponding to the unit area in which the flag indicating that the cleaner body has not traveled is written. Finally, if a point is regarded as a terminal point, mapping is completed. When the mapping is completed, the unit areas indicating walls and the unit areas indicating a traveling route are identified at sight. This is utilized as map information on each room.

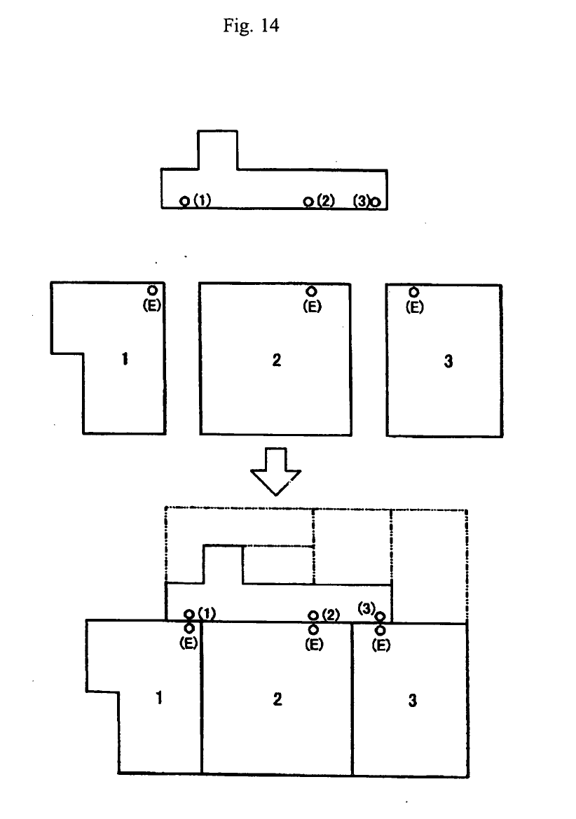

The foregoing mapping is completed for all rooms and a hall. As for the hall, the marker 85 is used to specify the entrances of the rooms. FIG. 14 shows a technique for joining produced pieces of map information on the rooms and hall. The room numbers (1 to 3) are assigned to the respective rooms, the doorways of the rooms are distinguished (with E), and the entrances of the rooms relative to the hall are numbered (1 to 3), whereby the pieces of map information on the rooms are joined on a planar basis.

(3) Actions of the Intercom

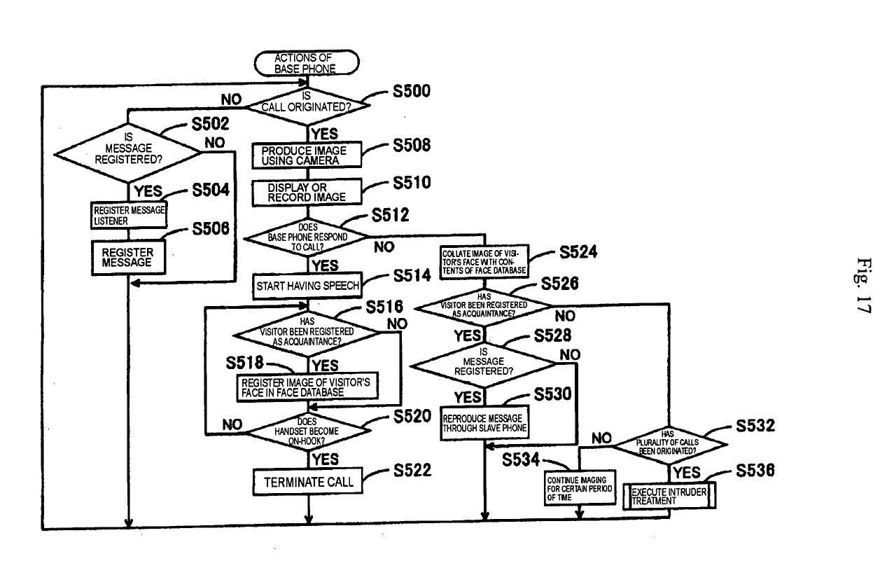

FIG. 17 is a flowchart describing the contents of base phone-side control extended by the base phone control circuit 93e and security control circuit 93f4 included in the base phone 93.

At step S500, whether a call is originated from the slave phone 93 is checked. If no call is originated from the slave phone, whether a message is registered is checked at step S502. The message is a verbal message which the slave phone 91 reproduces in response to an acquaintance's visit made when all the residents are out. A visitor is discriminated based on the visitor's face imaged by the camera device 91a in a manner described later. If a message is registered, a listener who should listen to the message is registered at step S504. At step S506, a message is registered. For registration of a listener, images of faces registered in the face database 93f1 are sequentially displayed on the display 93a. When an image of a specific face is displayed, the image is registered. When an image of a face is registered, an inherent ID number is assigned to the image. The audio signal representing the verbal message collected through the microphone 93c is recorded in association with the ID number in the message database 93f5. The base phone 93 repeats the above processing until a call is originated from the slave phone 91.

A visitor presses a calling button that is one of the operation switches 91d included in the slave phone 91. The slave phone control circuit 91c senses the press, and notifies the base phone 93 of a call. The base phone 93 senses the call at step S500, and uses the camera device 91a to image the visitor at step S508. The base phone 93 thus acquires photographic image data. At step S510, an image of the visitor's face is displayed on the display 93a according to the photographic image data, and the recording control circuit 93f2 additionally records the image data in the face database 93f1.

The base phone 93 reproduces a calling sound through the loudspeaker 93b in response to the call, and stands by for a resident's response. If the base phone is recognized at step S512 to have responded to the call responsively to a resident's response, a bidirectional speech circuit included in the base phone control circuit 93e allows the visitor to have speech with the resident. If the visitor having the image of his/her face displayed on the display 93a is the resident's acquaintance, the resident presses the operation switch 93d to register the image of the face as an image of an acquaintance. It the image of the face is recognized at step S516 to have registered as an image of an acquaintance, a property signifying that a visitor is a resident's acquaintance is appended to the image of the visitor's face, which has been additionally recorded in the face database 93f1, at step S518. Once the property signifying that a visitor is a resident's acquaintance is appended to the image of a face, when the face discrimination circuit 93f3 references the face database on the basis of a visitor's face, the visitor is identified as an acquaintance.

The base phone 93 has a switchhook to which a handset thereof is hung on. In order to originate a call, an off-hook condition is established, that is, the handset is off-hook. When the call is terminated, an on-hook condition is established, that is, the handset is on-hook. At step S520, whether an on-hook signal is present is checked to see if a call is terminated. When the handset goes on-hook, the bidirectional speech circuit included in the base phone control circuit 93e terminates the call at step S522.

The above procedure is followed when a resident is at home and the base phone returns a response. If the base phone does not return a response within a predetermined period of time, after check is performed at step S512, the face discrimination circuit 93f3 collates the image of a visitor's face with the contents of the face database 93f1 at step S524. If the image of the visitor's face is registered in the face database 93f1, the visitor is identified as an acquaintance. At step S528, the properties associated with the image of the visitor's face are checked to see if they include a property indicating presence of a message. If a message is stored, an ID number recorded in the face database is used to reference the message database 93f6 at step S530. A message recorded in association with the ID number is retrieved and reproduced using the slave phone 91.

For example, assume that although Ms. B is going to visit Ms. A at the house, Ms. A has to go out on urgent business and will be out for about 30 min. Ms. B has previously visited the house and has been registered as one of the acquaintances of Ms. A. Before leaving the house, Ms. A registers Ms. B as a listener of a message at step S504. At step S506, Ms. A records a message saying that she will be out for about 30 min and wants Ms. B to wait for her. When Ms. B comes and presses a Call button, the image of the visitor's face is automatically recorded at step S508. Since a resident does not respond to the call, the face database is referenced at step S524. Since Ms. B is registered as an acquaintance and a message is registered, after check is made at steps S526 and S528, the registered message is reproduced by the slave phone 91 at step S530. Consequently, Ms. B understands that Ms. A does not forget about Ms. B's visit but will return within 30 min, and determines to come here again in 30 min.

On the other hand, a visitor who is not an acquaintance is recognized as an intruder anyhow. Based on the images of the visitors' faces additionally recorded in the face database 93f1, whether a visitor having the image of his/her face registered additionally has originated a call several times is checked at step S532. Intruders normally originate a call several times so as to confirm that no resident is at home. If the visitor has not originated a call several times, low-level intruder treatment is performed at step S534. Namely, the visitor is continuously imaged using the camera device 91a for a certain period of time. After the certain time elapses, initial call waiting is performed. When a resident returns, he/she can check the visitor's face. If the visitor is an intruder, the resident can check how the visitor behaved in front of the slave phone 91.

If a visitor who is not an acquaintance originates a call several times, it is a dangerous situation. After check is performed at step S536, intruder treatment is executed.

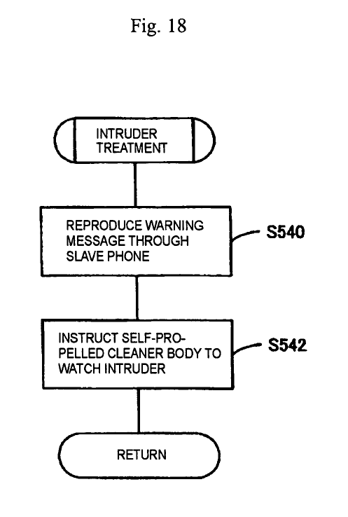

FIG. 18 is a flowchart describing intruder treatment. At step S540, the slave phone 91 reproduces a warning message. For example, assuming that a visitor's face has already been imaged and the visitor does not disappear, a message revealing an important finding is generated verbally. Normally, when a visitor has an image of his/her face recorded, the visitor will presumably give up actual invasion. The warning message is registered in advance in the message database 93f6. At step S542, the self-propelled cleaner body is instructed to watch the visitor. The instruction of watch is given by transmitting a predetermined infrared signal from the infrared communication unit 93f6.

According to the present embodiment, the base phone 93 included in the intercom is so sophisticated that it can keep phased watch according to a face or the like. However, the base phone 93 may not have the ability to check a visitor's face to see if the visitor is an intruder. In the simplest example, a call transferred from the slave phone 91 is left intact. The self-propelled cleaner body moves to the standby position in response to a calling sound generated by the base phone 93, and implements a watch mode that will be described later. The base phone 93 is more intelligent, it can cope with a more complex case. Consequently, the possibility of incorrect reporting will decrease. However, the self-propelled cleaner does not depend on the degree of sophistication of the base phone 93.

(4) Watch Mode in the Self-propelled Cleaner

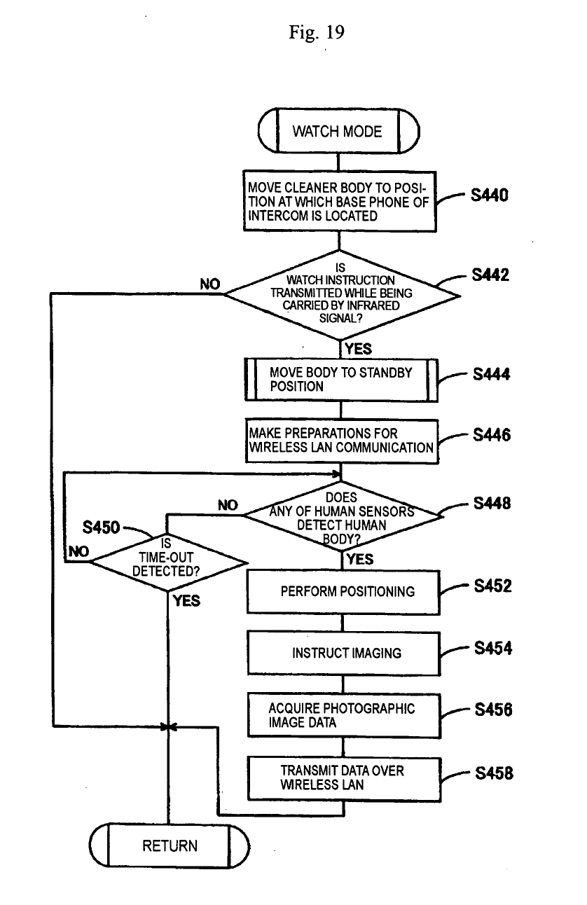

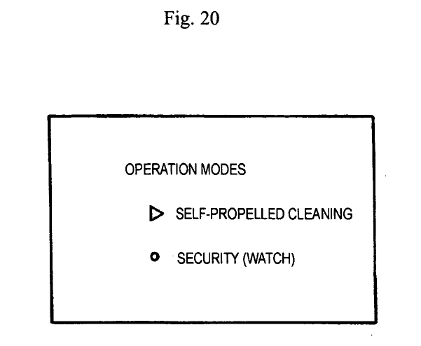

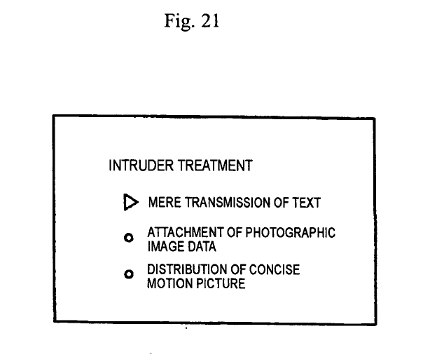

FIG. 19 is a flowchart describing watch-mode processing. FIG. 20 shows an operation mode selection display screen image. FIG. 21 shows a selection screen image through which treatment of an intruder is selected.

The self-propelled cleaner enables selection of any of operation modes shown in FIG. 20 on the liquid crystal display panel 15b. When the operation switch 15a is manipulated in order to select a security mode or a watch mode, the watch mode is implemented as described in FIG. 19. The watch mode is repeatedly initiated in response to a timer interrupt or the like.

Before the watch mode is initiated, the cleaner body must be moved to the special position 4 corresponding to the position of the base phone 93, which is included in the intercom, at step S440. A traveling route starting with a current position and ending with the special position 4 is calculated, and the cleaner body is moved along the traveling route. The moving procedure will be described later.

At the special position 4, the base unit 93 transmits an infrared signal, which carries a watch instruction, from the infrared communication unit 93f6. In the self-propelled cleaner, the infrared communication unit 83 receives the signal. As mentioned previously, the base unit 93 of the intercom may not be so sophisticated as to check a face or transmit an infrared signal. In this case, the self-propelled cleaner initiates an action in response to a calling sound generated by the intercom. Intruders often use, as mentioned above, the intercom to check if a resident is at home. When the watch mode is implemented because a resident is out, if a calling sound is generated from the intercom, it is highly probable that the presence of an intruder is suspected.

At step S442, whether the watch instruction is transmitted from the special position 4 while being carried by an infrared signal is checked. If the watch instruction is not transmitted, processing is suspended. The processing is repeatedly initiated in order to check whether the watch instruction is transmitted. If the watch instruction is transmitted while being carried by an infrared signal, the cleaner body is moved to the standby position, which is designated as a position to which an intruder is likely to invade, at step S444. Now, the procedure of moving the cleaner body to a special position will be described below.

If the standby position is designated as a special position using the marker 85, the traveling route starting with a current position and ending with the special position is determined. As mentioned previously, when map information is completed, the traveling route starting with the current position and ending with the designated position can be retrieved from the map information. A known method of resolving a labyrinth can be adopted for determination of the traveling route. For example, a right hand method is such that if a person moves from an entrance with his/her right hand in contact with a wall all the time, he/she will finally reach a goal. Thereafter, a redundant route is duly eliminated. For example, points traced while the cleaner body returns by turning 180° are duly eliminated. Moreover, since the cleaner body lies in a room, points traced while the cleaner body turns as if to draw a square bracket are searched. As long as no obstacle is found, points succeeding the points are designated in order to shorten a route. A traveling route may not be automatically determined but an interface through which a user can designate a traveling route may be provided for users. After a traveling route is thus determined, the cleaner body is moved along the traveling route.

As long as the foregoing mapping is performed, the standby position can be designated by selecting any of the special positions 1, 2, and 3. In a high-rise apartment building, a front door alone would serve as an entrance of invasion. Therefore, the special position 3 is designated as the standby position. In a lower story, the room 1 or 2 that opens upon a veranda may be designated as the standby position. In a detached house, a special position is determined in a room having a window through which an intruder is most likely to enter and then designated as the standby position.

On the other hand, since mapping is a sophisticated facility, the throughput of the CPU 11 or the storage capacity of the RAM 13 may be requested to be improved in order to implement mapping.

Even if the self-propelled cleaner merely has an ability to travel along a wall and the marker 85, it can move to the standby position. For traveling along a wall, the cleaner body advances until a wall is sensed in front according to the results of sensing sent from the AF passive sensors 31FM, 31FR, and 31FL, and makes a spin immediately ahead of the wall. Advancement is achieved by instructing the right and left drive wheel motors 42R and 42L to drive the respective drive wheels at the same rotating speed in the same direction by the same magnitude of rotation. When the cleaner body makes a spin, the results of sensing sent from the AF passive sensors 31R and 31L are received, and the cleaner body is halted at a position at which the distance to a wall located by the side of the cleaner body becomes shortest. At the position at which the distance to the wall located by the side of the cleaner body is shortest, the body BD is presumably nearly parallel to the wall. If the cleaner body advances from the position, it can move parallel to the wall. Meanwhile, the distance to the wall is monitored. If the distance increases or decreases, the magnitude of rotation by which the drive wheel motors 42R and 42L will rotate the drive wheels is increased or decreased in order to cancel out the increase or decrease in the distance. Thus, the direction of movement is corrected. Either of two motions may be made at a corner of a room. Namely, the cleaner body may abut on a wall at a corner of a room at which walls meet or may pass the corner. When a wall is sensed in front, the cleaner body may abut on the wall at the corner. The cleaner body therefore makes a spin immediately ahead of the wall and then travels in parallel with the wall. When the cleaner body passes a corner of a room, no wall is sensed any longer by the side of the cleaner body. In this case, the cleaner body makes a 90° spin so that it will lie in parallel with the other wall the cleaner has passed, and then advances. When a wall is sensed by the side of the cleaner body, the cleaner body further moves in parallel with the wall.

Traveling along a wall is achieved as mentioned above. The cleaner body moves while monitoring the sensing situation of the infrared communication unit 83 so as to check whether positional information sent from the marker 85 and carried by an infrared signal is received. If the positional information sent from the marker represents the special position 4 that is the position of the base phone 93 included in the intercom, a watch instruction to be sent from the base phone is waited for at the position. On receipt of the watch instruction from the base phone, the cleaner body continues traveling along a wall so as to search the designated standby position. More particularly, in order to search the standby position, the cleaner body restarts traveling along a wall while checking the presence or absence of a signal carrying positional information and being sent from the marker 85, and halts at the position of the marker 85 that produces a position signal which represents the standby position.

The foregoing traveling control sequence in which traveling along a wall is used in combination with the marker requires simple hardware and software configurations, and is therefore implemented at a low cost. The traveling control sequence is therefore highly feasible. Moreover, incorrect recognition of a position deriving from insufficient precision will not occur unlike when traveling is controlled based on map information. The traveling control sequence is therefore highly reliable. However, traveling based on map information has a merit that a traveling route is shortened because the shortest distance can be searched.

After the cleaner body moves to the standby position at step S444, preparations are made for wireless LAN communication at step 446. When a battery is used to drive the cleaner body, measures must be taken in order to save power. Discontinuation of power supply to the wireless LAN module 71 is needed depending on the necessity of communication. On the other hand, once power supply is discontinued, even if power supply is restarted, the wireless LAN module 71 cannot be put to use immediately. Therefore, when the cleaner body reaches the standby position, power supply is restarted immediately in order to make preparations for communication. Making preparations for communication is equivalent to sequential implementation of a predetermined procedure required by wireless LANs.

Thereafter, at step S448, the results of sensing sent from the human sensors 21fr, 21rr, 21fl, and 21rl are received. If the results of sensing are unavailable, a time-out is checked at step S450. The time-out is determined in consideration of a time interval during which an intruder can invade into a house. Unless the time-out is detected, the cleaner keeps watching at the standby position.

While the cleaner keeps watching, if any of the human sensors 21fr, 21rr, 21fl, and 21rl detects a human body, invasion of an intruder is suspected. At step S452, the position (direction) of an intruder is specified based on the results of sensing sent from the human sensors 21fr, 21rr, 21fl, and 21rl. The cleaner body makes a spin so as to direct the CMOS cameras 61 and 62 included in the camera system unit 60 to the intruder. At step S454, the CMOS cameras are instructed to image the intruder. At step S456, photographic image data is acquired. At step S458, the photographic image data is transmitted over a wireless LAN.

During positioning, first, the angle of the body BD relative to an object to be sensed is detected based on the results of sensing sent from the human sensors 21fr, 21rr, 21fl, and 21rl. The human sensors 21 may be of a type that produces a signal proportional the intensity of infrared light emitted from an infrared-emitting moving object or of a type that produces a signal representing the presence or absence of the infrared-emitting moving object.

When the human sensors 21 produce a signal proportional to the intensity of infrared light, the plurality of human sensors 21 rather than only one human sensor will sense the intensity. In this case, the outputs of two human sensors 21 representing high intensities are used to sense the angle of an infrared-emitting moving object within an angular range of 90° defined by the directions in which the two human sensors are facing. The ratio of the intensities represented by the outputs of the two human sensors 21 is calculated and used to reference a table produced in advance on the basis of the results of experiments. In the table, the ratios of intensities are recorded in association with angles. Therefore, the angle of the object to be sensed within the angular range of 90° can be determined. Moreover, the angle of the object to be sensed relative to the body BD is calculated based on the positions of the two human sensors 21 whose outputs are utilized. For example, assume that the two human sensors 21 whose outputs represent high intensities are the human sensors 21fr and 21rr mounted on the right flank of the body BD, and that the angle of 30° of the object to be sensed relative to the human sensor 21fr within the angular range of 90° is retrieved from the table on the basis of the ratio of intensities. In this case, since the object to be sensed lies at the angle of 30° with respect to the front-side sensor within the angular range of 90° on the right flank of the body, the angle of the object to be sensed relative to the front side of the body comes to 45°+30°=75°.

On the other hand, when the human sensors 21 produce a signal representing the presence or absence of an infrared-emitting moving object, eight relative angles with respect to the body BD are sensed fundamentally. Namely, when any of the human sensors 21 produces an output, the angle at which any of the human sensors 21 having produced the output is mounted is regarded as a relative angle. When two human sensors 21 produce an output, an angle at an intermediate position between the positions of the two human sensors 21 is regarded as the relative angle. When three human sensors 21 produce an output, an angle at the position of the middle human sensor 21 is regarded as the relative angle. In short, when a plurality of human sensors is mounted equidistantly, if an even number of human sensors produces an output, an angle at an intermediate position is adopted. If an odd number of human sensors produces an output, an angle at the position of the middle human sensor is adopted.

After the relative angle is sensed as mentioned above, positioning is performed in order to drive the right and left drive wheels so that the front of the body BD will face in a direction determined with the relative angle. Positioning is achieved by turning the body in the same place. The motor drivers 41R and 41L are instructed to drive the right and left drive wheel motors 42R and 42L in opposite directions by predetermined magnitudes of rotation.

Preferably, photographic image data is acquired using the two CMOS cameras 61 and 62. However, depending on a user's choice, continuous imaging to be performed using a wide angle camera may be selected or continuous imaging to be performed using a standard camera may be selected. Moreover, depending on a situation, after the wide angle camera is used to produce only one image, the standard camera may be used for imaging. If it takes much time to transfer photographic image data, the number of images produced by the wide angle camera should be one in consideration of the time required for transmission of a plurality of photographic image data items. Production of a plurality of images using the standard camera would have more significant meanings. Moreover, in order to compensate a narrow imaging range covered by the standard camera, the body BD may be turned a bit after every completion of imaging. Namely, imaging, turning the body a bit, and imaging may be repeated. In this case, first, the body is turned to face in a direction permitting canceling out of the relative angle. Thereafter, the body is turned slightly counterclockwise with the position as a reference. Thereafter, the body is turned clockwise in order to perform imaging. The width of the swing may be gradually increased in order to widen the imaging range.

Photographic image data is transmitted over a wireless LAN. A destination may be a specific domain in which a server is included. The photographic image data may be transmitted as an attachment to an e-mail message over the Internet. In this case, as shown in FIG. 21, any of treatments of an intruder can be selected on the liquid crystal display panel 15b. In the example shown in FIG. 21, “Mere transmission of a text,” “Attachment of image data,” and “Distribution of a concise motion picture” are presented. Any of these treatments can be selected using the operation switch 15a. When attachment of image data is selected, the photographic image data is transmitted as an attachment to an e-mail message. When distribution of a concise motion picture is selected, the photographic image data produced using the two CMOS cameras 61 and 62 is repeatedly transmitted.

The camera system unit 60 need not always be included in the self-propelled cleaner. If the self-propelled cleaner includes no camera, mere transmission of a text file would be effective. In particular, as far as a house in which a resident uses a web camera system independently of the self-propelled cleaner is concerned, a resident who has received the text file may use another access method to monitor the situation of his/her house using the web camera system.

Consequently, the user who stays out uses a portable cellular phone to receive an e-mail message, and grasps the situation of the house. If the e-mail message is accompanied by an image, the user grasps the situation of the house in more detail and takes measures. For example, the user contacts a security company or goes to the police and asks them to rush to the house.

As described previously, while the cleaner body roams about a room to clean the room at steps S400 to S422, map information is produced. Moreover, when the cleaner body passes near the marker 85, positional information received from the marker is added to the map information. The marker 85 is used to specify the position of the base phone 93 of the intercom or a standby position as any of the special positions 1 to 4. Information on a specific position where the cleaner should watch an intruder can be readily added to the map information. In the watch mode, whether the watch instruction is received from the base phone 93 is checked at step S442. After the cleaner body moves to the standby position at step S444, the human sensors 21 are used to sense invasion of an intruder at step S448. As soon as invasion is sensed, the cleaner body spins to face the intruder at step S452. Imaging is instructed at step S454, and photographic image data is acquired at step S456. The photographic image data is transmitted over a wireless LAN at step S458. Thus, when the self-propelled cleaner is interlocked with the intercom, watch on an intruder and defense against the intruder can be upgraded.

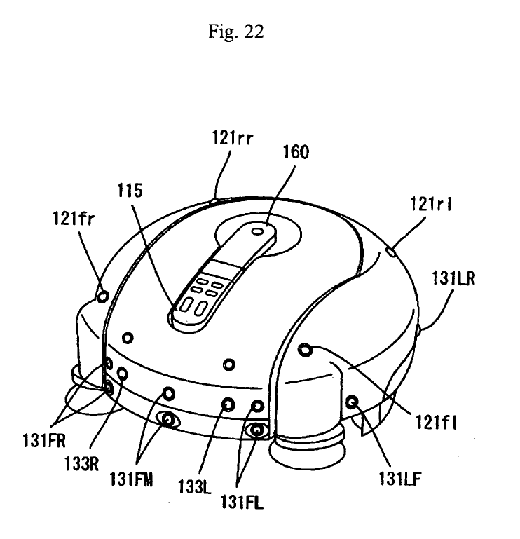

FIG. 22 shows the appearance of another embodiment of the present invention.

As the human sensing unit 20, four human sensors 121 (121fr, 121rr, 121fl, and 121rl) are disposed to face in obliquely right and left forward directions and in obliquely right and left backward directions. The human sensors 21 include an infrared light receiving sensor and sense the presence or absence of a human body on the basis of a change in an amount of received infrared light.

The obstacle monitoring unit 30 employs an ultrasonic sensor on behalf of the AF range-finding sensor mounted on the front side of the cleaner body. Herein, ultrasonic sensors 131FR, 131FM, and 131FL take charge of a forward region on behalf of the AF passive sensors 31FR, 31FM, and 31FL mounted on the front side of the cleaner body. The ultrasonic sensors are each composed of a pair of an ultrasound transmission unit and an ultrasound reception unit. The ultrasound reception unit receives ultrasonic waves transmitted from the ultrasound transmission unit and reflected from an obstacle. The presence or absence of an obstacle or the distance to the obstacle is measured based on a time difference or a phase difference.

On the other hand, photo-reflectors 131RF, 131RR, 131LF, and 131LR are included for sensing the presence or absence of a wall in cooperation with the AF passive sensors 31R and 31L. The photo-reflectors 131RF and 131LF are mounted on the front sides of the flanks of the body. Similarly to the AF passive sensors 31R and 31L, the photo-reflectors 131RF and 131LF check a region spread laterally ahead of the front of the body so as to sense the presence or absence of a wall or measure the distance to the wall. The photo-reflectors 131RR and 131LR check a region spread laterally behind the back of the body so as to sense the presence or absence of a wall or measure the distance to the wall. The AF passive sensors 31R and 31L can merely detect the presence or absence of a wall located ahead of the body or measure the distance to the wall. The inclusion of the photo-reflectors 131RR and 131LR permit detection of the presence or absence of a wall located behind the body or measurement of the distance to the wall. Even when the body spins, the distance to a wall or an obstacle can be measured if necessary. The photo-reflectors are each composed of a light-emitting unit and a light-receiving unit. The light-receiving unit receives light irradiated from the light-emitting unit and reflected from an obstacle, and detects the presence or absence of an obstacle or measures the distance to the obstacle on the basis of the amount of received light.

On the other hand, the photo-reflectors 131RF and 131LF cannot, unlike the AF passive sensors 31R and 31L, sense a step located forward. Photo-reflectors are circumferentially mounted on the bottom of the body and oriented downward, though they are not shown. The photo-reflectors facing downward are used to detect a step, or more particularly, stairs.

The ultrasonic sensors 131FR, 131FM, and 131FL sense an obstacle located forward, the photo-reflectors 131RF and 131LF detect the presence or absence of a wall located by the side of the body or measure the distance to the wall, and the photo-reflectors that are mounted on the bottom of the body and are not shown sense a step located below in the forward direction. Thus, the present embodiment can perform the same movements and actions as those of the aforesaid embodiment. Moreover, the actions can be controlled for the same purpose by making the most of the properties of the ultrasonic sensors and photo-reflectors.

The self-propelled cleaner stands by at a watch position by making the most of its ability to propel oneself while being interlocked with the intercom. When the self-propelled cleaner senses the presence of an invader, it reports the fact to a resident, who stays out, over a wireless LAN. This results in upgraded watch and defense.

1. A self-propelled cleaner being used in combination with an intercommunication system (intercom) that includes a camera device which images a visitor, that stepwise determines a visitor's degree of danger on the basis of a visitor's face imaged by the camera device, and that notifies outside of the result of the determination, and having a body that includes a cleaning mechanism, and a drive mechanism that includes drive wheels which are disposed on the right and left of the body, whose rotations can be controlled independently of each other, and with which steering and driving are achieved, comprising:
an intruder information acquisition processor that acquires information on an intruder's visit from the intercom;
wireless LAN communication equipment that transmits or receives predetermined information to or from outside over a wireless LAN;
a mapping processor that while the body propels itself to roam about a room, produces and preserves map information, and that while the body propels itself within the room, acquires positional information from a marker that is located at a specific standby position and transmits predetermined positional information, and adds the positional information to the map information;
a route derivation processor that derives a traveling route starting with a current position and ending with a position designated as the standby position;
a movement control processor that when information on an intruder's visit is acquired from the intercom, instructs the route derivation processor to derive a traveling route, and instructs the drive mechanism to move the body to the specific position along the traveling route;
a human body detector that detects the presence or absence of a human body in the vicinity;
a camera device that transmits photographic image data representing a produced image; and
a reporting control processor that instructs the human body detector to keep detecting the presence or absence of a human body at the standby position, and that when a human body is detected, and instructs the camera device to image the human body, instructs the wireless LAN communication equipment to report the fact to a predetermined address and to transmit the photographic image data to the predetermined address.

2. A self-propelled cleaner having a body that includes a cleaning mechanism, and a drive mechanism that steers or drives the body, comprising:
radiocommunication equipment that transmits or receives predetermined information to or from outside by radio;
an intruder information acquisition processor that acquires information on an intruder's visit from an external intercom;
a movement-to-standby position control processor that when the information on an intruder's visit is acquired, controls the drive mechanism so that the body will move to a predetermined standby position that is a position designated in advance;
a human body detector that detects the presence or absence of a human body in the vicinity; and
a reporting control processor that instructs the human body detector to keep detecting the presence or absence of a human body at the standby position, and that when a human body is detected, instructs the radiocommunication equipment to report the fact to a predetermined address.

3. The self-propelled cleaner according to claim 2, wherein the radiocommunication equipment includes a wireless LAN module, and transmits or receives information to or from outside via the wireless LAN module.

4. The self-propelled cleaner according to claim 2, wherein the movement-to-standby position control processor has a wall sensor, which detects surrounding walls, incorporated in the body, receives the result of detection from the wall sensor and controls the drive mechanism so that the body will travel along the walls, acquires positional information from a marker that is located by the side of a wall and that is designed to transmit the positional information, and determines whether movement of the body to the standby position is completed.

5. The self-propelled cleaner according to claim 2, wherein the movement-to-standby position control processor comprises:
a mapping processor that while the body propels itself to roam about a room, produces and preserves map information on the interior of a room, and that while the body propels itself within the room, acquires positional information from a marker which is located at a specific position and designed to transmit predetermined positional information, and adds the positional information to the map information;
a route derivation processor that derives a traveling route starting with a current position and ending with a position designated as the specific position; and
a movement control processor that instructs the route derivation processor to derive a traveling route, and that instructs the drive mechanism to move the body to the specific position along the traveling route.

6. The self-propelled cleaner according to claim 2, further comprising a camera device that transmits photographic image data representing a produced image, wherein the reporting control processor instructs the camera device to produce an image when reporting detection of a human body, and instructs the radiocommunication equipment to transmit photographic image data to a predetermined address.

7. The self-propelled cleaner according to claim 2, wherein the intercom includes a camera device that images a visitor, stepwise determines a visitor's degree of danger on the basis of a visitor's face imaged by the camera device, and notifies outside of the result of the determination.
